(19) United States
(12) Patent Application Publication
(10) Pub. No.: US 2008/0290841 A1
(43) Pub. Date: Nov. 27, 2008

(54) Charging Circuit for Bootstrap Capacitor and Integrated Driver Circuit Using Same

(75) Inventors: Kuang-Ming Chang, Chungli City (TW); Chien-Hsing Cheng, Taipei (TW)

Correspondence Address: Tung & Associates, Suite 120, 838 W. Long Lake Road, Bloomfield Hills, MI, 48302, US

(73) Assignee: Richtek Technology Corporation

(21) Appl. No.: 11/752,441

(22) Filed: May 23, 2007

(51) Int. Cl. H02J 7/00

(52) U.S. Cl. 320/166

(57) ABSTRACT

The present invention discloses a charging circuit for charging a bootstrap capacitor from a supply voltage, the charging circuit comprising: a depletion mode transistor, having a first end of its source/drain electrically connected with the supply voltage, a gate electrically connected to the supply voltage, and a second end of its source/drain electrically connected with the bootstrap capacitor. Preferably, a diode is provided between the supply voltage and the depletion mode transistor.

### FIELD OF INVENTION

The present invention relates to a charging circuit for bootstrap capacitor and an integrated driver circuit using the charging circuit, in particular to one adapted for use in a high voltage half-bridge power supplier circuit.

### BACKGROUND OF THE INVENTION

A typical structure of a half-bridge power supplier circuit, also referred to as a switching regulator, is shown in FIG. 1, in which two power transistors Q1 and Q2 respectively switch ON and OFF to convert the supply voltage Vcc to a desired voltage required by the load 20. The ON/OFF states of the two power transistors Q1 and Q2 are respectively controlled by an up-gate driver circuit 11 and a low-gate driver circuit 12 in a driver IC 10, in which the node voltage Vph is the floor of the voltage range where the up-gate driver circuit 11 operates, and ground voltage is the floor of the voltage range where the low-gate driver circuit 12 operates. (The other parts of the driver IC are omitted for simplicity.)

When the supply voltage Vcc is a high voltage (such as several hundred volts), the up-gate driver circuit 11 should not directly receive operating voltage from the supply voltage Vcc. Hence, as shown in the figure, a bootstrap capacitor C1 is provided. When the transistor Q2 is ON, a low voltage supply source Vdd in the IC 10 charges the bootstrap capacitor C1 through a bootstrap diode D1, so that when the transistor Q2 is OFF, the voltage at the node N1 reaches Vph+Vdd, for operating the up-gate driver circuit 11. The bootstrap diode D1 serves to prevent the voltage at the node N1 from damaging the low voltage supply source Vdd when the voltage at the node N1 is higher than the low voltage supply source Vdd.

In the above arrangement, the voltage at the node N1 may be very high, and therefore the requirements to the capacitance rating of the bootstrap capacitor C1, and the breakdown voltage rating and peak current capacity rating of the bootstrap diode D1 are very high. For this reason, the bootstrap capacitor C1 and the bootstrap diode D1 are usually made by discrete components external to the IC 10.

U.S. Pat. No. 5,373,435 discloses a bootstrap diode emulator (BDE), which emulates the function of the bootstrap diode D1 by means of a complicated circuit. The concept of the BDE circuit is shown in FIG. 2 while its detailed structure is shown in FIG. 3. The purpose of this patent is to replace the discrete diode by the BDE so that it can be integrated in the IC 10.

However, it can be seen from the specification and figures of the U.S. Pat. No. 5,373,435 that the BDE circuit is very complicated—in addition to the number of devices, the circuit includes both MOS and bipolar transistors, which is disadvantageous in circuit integration and manufacture.

In view of the foregoing disadvantages in the prior art, the present invention proposes a charging circuit for bootstrap capacitor, which is much simpler in structure as compared with the prior art; the charging circuit can be integrated in an IC chip easily, and the IC chip can be manufactured by MOS process.

### SUMMARY OF THE INVENTION

A first objective of the present invention is to provide a charging circuit for bootstrap capacitor with a simple structure.

A second objective of the present invention is to provide an integrated driver circuit (driver IC) using the charging circuit for bootstrap capacitor

A third objective of the present invention to provide a half-bridge power supplier circuit using the integrated driver circuit.

In accordance with the foregoing and other objectives of the present invention, and as disclosed by one embodiment of the present invention, a charging circuit for charging a bootstrap capacitor from a supply voltage is disclosed. The charging circuit comprises: a depletion mode transistor, having a first end of its source/drain electrically connected with the supply voltage, a gate electrically connected to the supply voltage, and a second end of its source/drain electrically connected with the bootstrap capacitor. Preferably, a diode is provided between the supply voltage and the depletion mode transistor.

According to another aspect of the present invention, an integrated driver circuit for controlling at least a power transistor is disclosed. The integrated driver circuit comprises: an up-gate driver circuit for controlling a first power transistor, the up-gate driver circuit having a first voltage terminal electrically connected with a first voltage node, and a second voltage terminal electrically connected with a second voltage node; and a depletion mode transistor, having a first end of its source/drain electrically connected with a supply voltage, a gate electrically connected to the supply voltage, and a second end of its source/drain electrically connected with the first voltage node.

According to yet another aspect of the present invention, a half-bridge power supplier circuit for supplying a voltage to a load is disclosed. The half-bridge power supplier circuit comprises: a first and a second power transistors electrically connected with each other; an up-gate driver circuit for controlling the first power transistor, the up-gate driver circuit having a first voltage terminal electrically connected with a first voltage node, and a second voltage terminal electrically connected with a second voltage node; a low-gate driver circuit for controlling the second power transistor; a bootstrap capacitor electrically connected between the first voltage node and the second voltage node; and a depletion mode transistor, having a first end of its source/drain electrically connected with a supply voltage, a gate electrically connected to the supply voltage, and a second end of its source/drain electrically connected with the first voltage node.

Preferably, in the aforementioned charging circuit, the integrated driver circuit, and the half-bridge power supplier circuit, a diode is provided between the supply voltage and the depletion mode transistor. The anode of the diode is electrically connected with the supply voltage, and the cathode of the diode is electrically connected with the first end of the depletion mode transistor.

It is to be understood that both the foregoing general description and the following detailed description are provided as examples, for illustration rather than limiting the scope of the invention.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram showing a conventional half-bridge power supplier circuit, in which the bootstrap capacitor and the bootstrap diode are made by discrete components;

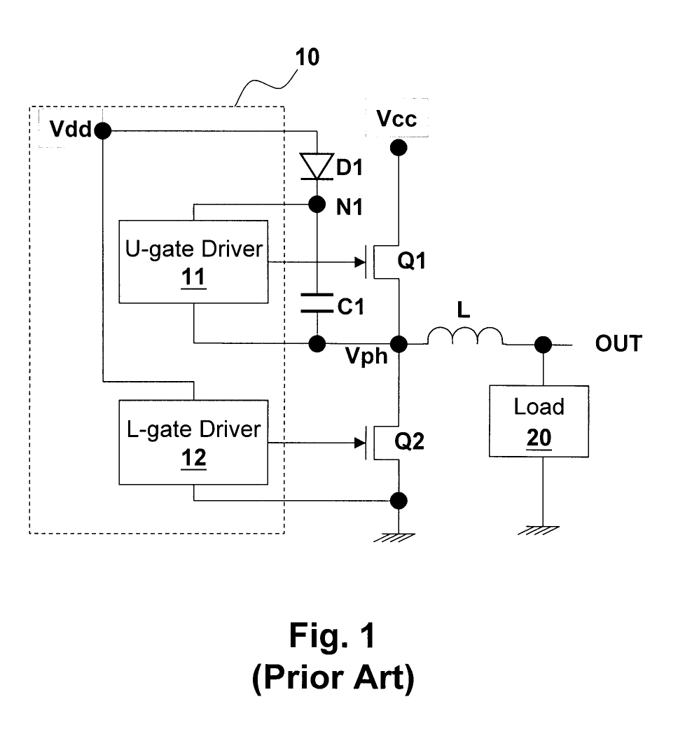

FIG. 2 is a simplified schematic circuit diagram of a conventional circuit in which a bootstrap diode emulator (BDE) replaces the discrete bootstrap diode;

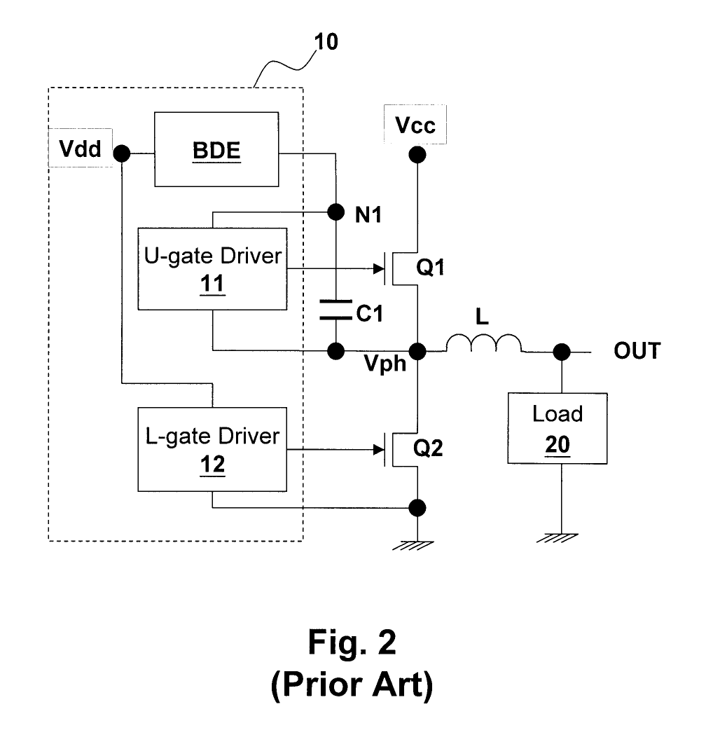

FIG. 3 is a schematic circuit diagram showing the detailed structure of the BDE in FIG. 2;

FIG. 4 is a schematic circuit diagram showing a first embodiment of the present invention; and

FIG. 5 is a schematic circuit diagram showing a second embodiment of the present invention.

### DESCRIPTION OF THE PREFERRED EMBODIMENTS

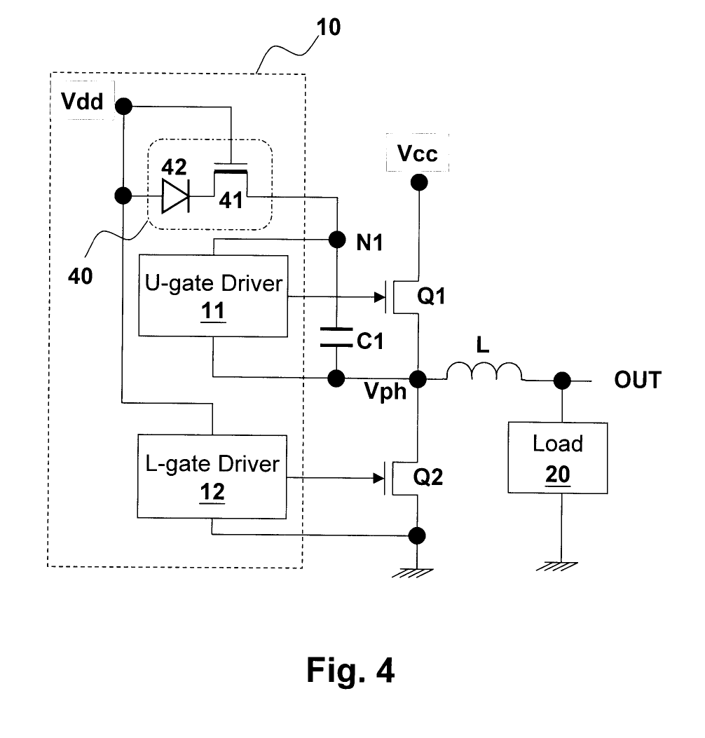

FIG. 4 is a schematic circuit diagram illustrating an embodiment of the present invention. According to the present embodiment, a charging circuit 40 for bootstrap capacitor is provided between the low voltage supply source Vdd and the bootstrap capacitor C1. The charging circuit 40 for bootstrap capacitor includes an N-type depletion mode transistor 41 and a diode 42. Preferably, the N-type depletion mode transistor 41 is a lateral diffused metal-oxide-silicon (LDMOS) device for that its process integration and device characteristics better meet the requirements of the present invention. When the voltage supplied by the low voltage supply source Vdd is higher than the voltage at the node N1, the left end of the depletion mode transistor 41 may be taken as its source; because the gate-to-source voltage Vgs of the depletion mode transistor 41 is positive (equivalent to the voltage drop of the diode 42), the depletion mode transistor 41 is kept conductive so that the low voltage supply source Vdd charges the bootstrap capacitor C1.

When the low transistor Q2 is OFF, the voltage at the node N1 equals to Vph+Vdd. Thus, the right end of the depletion mode transistor 41 has a voltage higher than that at its left end. However, due to the current limiting capability of the depletion mode LDMOS 41, a relatively low rating diode 42 is sufficient to prevent current from flowing in a reverse direction and provide a negative bias between the source and gate of the depletion mode LDMOS 41. The negative bias will turn off the depletion mode LDMOS 41. Because the present invention does not require a high rating diode, the depletion mode transistor 41 and the diode 42 can be integrated in the driver IC 10.

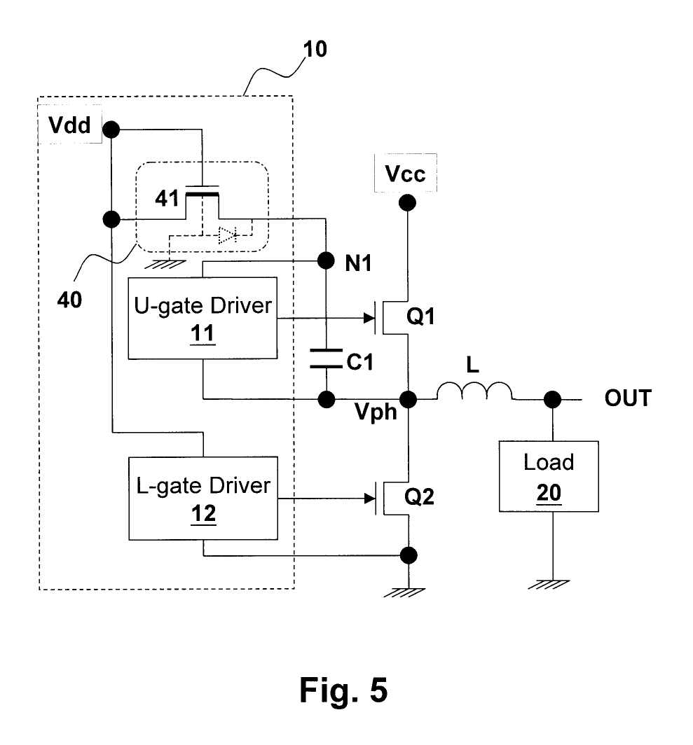

The diode 42 in the aforementioned embodiment is provided for safety; in fact, it can be omitted as shown in FIG. 5. In the embodiment shown in FIG. 5, when the voltage supplied by the low voltage supply source Vdd is higher than the voltage at the node N1, the gate-to-source voltage Vgs of the depletion mode transistor 41 is zero, so the depletion mode transistor 41 is conductive. On the other hand, when the voltage at the node N1 is higher than the low voltage supply source Vdd, the negative bias voltage at bulk end will pinch off the depletion channel, so that the depletion mode transistor 41 is cut off and non-conductive, as shown by the parasitic diode in the diagram.

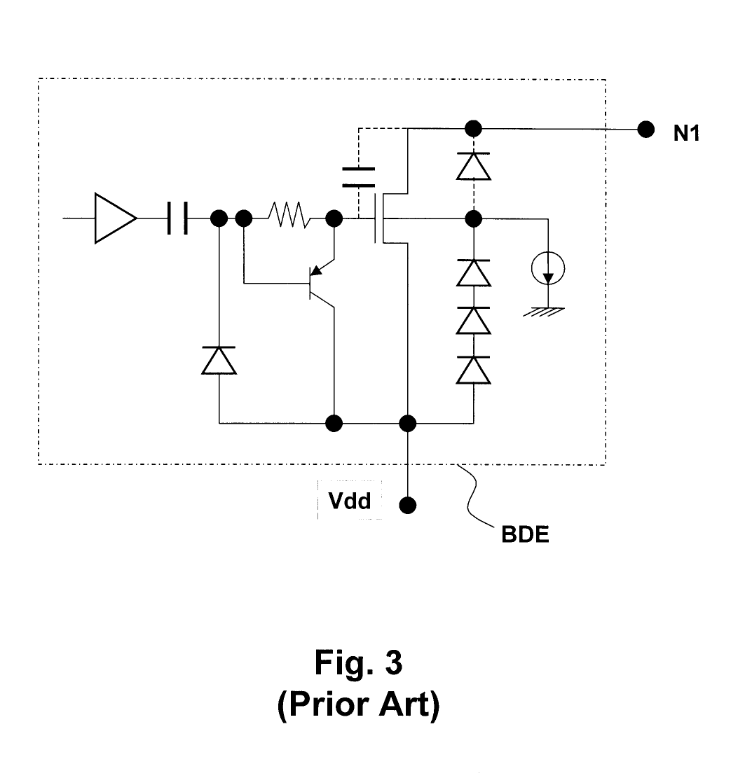

The two embodiments described above do not involve a complicated structure. The shown circuits are much simpler than the prior art circuit shown in FIG. 3; moreover, they do not require a complicated BiCMOS process to manufacture.

The present invention has been described in considerable detail with reference to certain preferred embodiments thereof. It should be understood that the description is for illustrative purpose rather than for limiting the scope of the present invention. The spirit of the invention is to construct a charging circuit for a bootstrap capacitor by a depletion mode transistor; due to its normally conductive, current limiting and cut-off characteristics, the low voltage supply source Vdd is protected without complicated circuit structure. Under the same spirit, one skilled in this art may readily conceive other variations and modifications. For example, one may insert a circuit device which does not affect the primary function of the circuit between two of the illustrated devices. As another example, the bootstrap capacitor is not limited to the bootstrap capacitor used in a half-bridge power supplier circuit, but instead can be any capacitor in another type of circuit. As a further example, the low transistor in the half-bridge power supplier circuit can be replaced by a diode. In view of the foregoing, it is intended that the present invention cover all such modifications and variations, which should be interpreted to fall within the scope of the following claims and their equivalents.

What is claimed is:

1. A charging circuit for charging a bootstrap capacitor from a supply voltage, the charging circuit comprising:
a depletion mode transistor, having a first end of its source/drain electrically connected with the supply voltage, a gate electrically connected to the supply voltage, and a second end of its source/drain electrically connected with the bootstrap capacitor.

2. The charging circuit of claim 1, further comprising a diode having an anode electrically connected with the supply voltage and a cathode electrically connected with the first end of the depletion mode transistor.

3. The charging circuit of claim 1, wherein the depletion mode transistor is a lateral diffused metal-oxide-silicon (LDMOS) device.

4. An integrated driver circuit for controlling at least a power transistor, the integrated driver circuit comprising:
an up-gate driver circuit for controlling a first power transistor, the up-gate driver circuit having a first voltage terminal electrically connected with a first voltage node, and a second voltage terminal electrically connected with a second voltage node; and
a depletion mode transistor, having a first end of its source/drain electrically connected with a supply voltage, a gate electrically connected to the supply voltage, and a second end of its source/drain electrically connected with the first voltage node.

5. The integrated driver circuit of claim 4, wherein the first voltage node and the second voltage node are respectively electrically connected with two ends of a bootstrap capacitor.

6. The integrated driver circuit of claim 5, wherein the bootstrap capacitor is located external to the integrated driver circuit.

7. The integrated driver circuit of claim 4, further comprising a diode having an anode electrically connected with the supply voltage and a cathode electrically connected with the first end of the depletion mode transistor.

8. The integrated driver circuit of claim 4, further comprising a low-gate driver circuit for controlling a second power transistor.

9. The integrated driver circuit of claim 4, wherein the depletion mode transistor is a lateral diffused metal-oxide-silicon (LDMOS) device.

10. A half-bridge power supplier circuit for supplying a voltage to a load, the half-bridge power supplier circuit comprising:
a first and a second power transistors electrically connected with each other;
an up-gate driver circuit for controlling the first power transistor, the up-gate driver circuit having a first voltage terminal electrically connected with a first voltage node, and a second voltage terminal electrically connected with a second voltage node;
a low-gate driver circuit for controlling the second power transistor;
a bootstrap capacitor electrically connected between the first voltage node and the second voltage node; and
a depletion mode transistor, having a first end of its source/drain electrically connected with a first supply voltage, a gate electrically connected to the first supply voltage, and a second end of its source/drain electrically connected with the first voltage node.

11. The half-bridge power supplier circuit of claim 10, further comprising a diode having an anode electrically connected with the first supply voltage and a cathode electrically connected with the first end of the depletion mode transistor.

12. The half-bridge power supplier circuit of claim 10, wherein the first power transistor having one end electrically connected with a second supply voltage, the second supply voltage being higher than the first supply voltage.

13. The half-bridge power supplier circuit of claim 10, wherein the depletion mode transistor is a lateral diffused metal-oxide-silicon (LDMOS) device.
